(19) United States
(12) Patent Application Publication
(10) Pub. No.: US 2017/0106929 A1
(43) Pub. Date: Apr. 20, 2017

(54) Bicycle Illumination System

(71) Applicant: William Deckard, Richboro, PA (US)

(72) Inventor: William Deckard, Richboro, PA (US)

(21) Appl. No.: 15/396,683

(22) Filed: Jan. 1, 2017

Related U.S. Application Data
(63) Continuation-in-part of application No. 12/907,143, filed on Oct. 19, 2010, now abandoned.

(51) Int. Cl. B62J 6/00; B62J 1/28

(52) U.S. Cl. CPC B62J 6/00; B62J 6/001; B62J 1/28; B62J 2300/002

(57) ABSTRACT

A bicycle that is illuminated using light arrays mounted to its seat. The bicycle has a frame that extends from a front first end and an opposite rear second end. A seat is mounted to the frame between the first end and the second end. A first light array is supported by the seat that illuminates the frame between the seat and the first end of the frame. A second light array is also supported by the seat. The second light array illuminates the frame between the seat and the second end of the frame. Light from the arrays illuminates the frame of the bicycle and the area surrounding the bicycle. This makes the bicycle far more noticeable during low-light conditions.

### RELATED APPLICATIONS

This application is a Continuation-In-Part of co-pending U.S. patent application Ser. No. 12/907,143 filed Oct. 19, 2010.

### BACKGROUND OF THE INVENTION

1. Field of the Invention

In general, the present invention relates to illumination systems for bicycles. More particularly, the present invention relates to illumination systems for the seats of bicycles.

2. Prior Art Description

Because a child on a bicycle is small, fast and often does not obey the rules of the road, such a child is difficult to see by a driver of a motor vehicle. This is especially true in twilight or at night when lighting is poor. To help increase the visibility of bicycles, many bicycles are now sold with reflectors. The reflectors are typically located on the wheels of the bicycle and on the pedals of the bicycle.

In order for a reflector to be visible, it must reflect light. Accordingly, bicycle reflectors are most effective when a bicycle is located in front of the headlights of an automobile and there is a bright light to reflect. However, such bicycle reflectors are not nearly as noticeable if the bicycle is located to the side of the automobile and/or out of the direct line of the beams of the headlights.

To help improve the visibility of bicycles, bicycles are often equipped with safety lights. Safety lights are self-illuminating. Accordingly, safety lights do not rely upon the reflection of headlights and the safety lights can be seen at any angle of approach to the bicycle.

In the prior art record, there are many different types of safety lights for bicycles. Safety light assemblies have been designed for many different parts of the bicycle, such as the handlebars and wheels. However, the present invention addresses light systems that are designed as part of a bicycle seat.

In the prior art, there are many lighting systems that attach to a bicycle seat. In all of the prior art systems, the lights are positioned on the rear of the seat and shine light toward the rear of the bicycle. The lighting systems provide no light to the sides of the bicycle. Such rearwardly facing bicycle seat lights are exemplified by U.S. Pat. No. 5,457,612 to Carter, entitled, Bicycle Rear Lighting System and U.S. Pat. No. 7,431,393 to Huang, entitled Bicycle Saddle Mount With Light Device.

The seat of a bicycle is often the highest part of a bicycle. Accordingly, lights affixed to a bicycle seat would be the easiest to see, especially by a person seated within an automobile. However, since prior art light systems only shine light rearwardly from a bicycle seat, such lighting systems cannot be viewed from the sides or front of the bicycle. Such prior art lighting systems, therefore, have only limited value.

Another disadvantage of prior art bicycle seat lighting devices is that all have manual on/off controls. As such, a bicycle rider must actively turn the bicycle seat lighting device either on or off. Children, who ride bicycles often, are likely to forget to turn the bicycle seat light on when necessary. Furthermore, once it is turned on, they may likely forget to turn it off and the batteries will quickly die.

A need therefore exists for an improved bicycle seat illumination system that shines light to the sides of a bicycle rider as well as to the rear of the rider. A need also exists for an improved bicycle seat illumination system that automatically turns on and off, therein ensuring the system is in operation when needed and is conserving battery life when not needed. These needs are met by the present invention as described and claimed below.

### SUMMARY OF THE INVENTION

The present invention is a bicycle that is illuminated using light arrays mounted to its seat. The bicycle has a frame that extends from a front first end and an opposite rear second end. A seat is mounted to the frame between the first end and the second end. A first light array is supported by the seat that illuminates the frame between the seat and the first end of the frame. A second light array is also supported by the seat. The second light array illuminates the frame between the seat and the second end of the frame. Light from the arrays illuminate the frame of the bicycle and the area surrounding the bicycle. This makes the bicycle far more noticeable during low-light conditions.

A battery supply powers the light arrays. The activation of the light arrays is governed by at least one controller. The controller detects if the bicycle is actually in use. The light arrays automatically activate if the bicycle is in use, provided some ambient lighting criteria are met. Conversely, the light arrays automatically deactivate when the bicycle is not in use and/or some ambient lighting conditions are met.

### BRIEF DESCRIPTION OF THE DRAWINGS

For a better understanding of the present invention, reference is made to the following description of exemplary embodiments thereof, considered in conjunction with the accompanying drawings, in which:

FIG. 1 is a side view of an exemplary embodiment of an illuminated bicycle assembly;

FIG. 2 is a top view of the exemplary embodiment shown in FIG. 1;

FIG. 3 is an enlarge perspective view of the seat assembly used as part of the bicycle;

FIG. 4 is a top view of the bicycle seat;

FIG. 5 is a schematic of the electrical components of the bicycle assembly;

FIG. 6 is a perspective view of an alternate embodiment of the present invention system;

FIG. 7 is a perspective view of an alternate embodiment of the present invention system; and

FIG. 8 is a schematic of an alternate embodiment of a seat assembly.

### DETAILED DESCRIPTION OF THE DRAWINGS

Although the present invention illumination system can be adapted to many types of bicycles, the embodiments illustrated show the system being used applied to a traditional touring bicycle. These embodiments are selected in order to set forth some of the best modes contemplated for the invention. The illustrated embodiments, however, are merely exemplary and should not be considered a limitation when interpreting the scope of the appended claims.

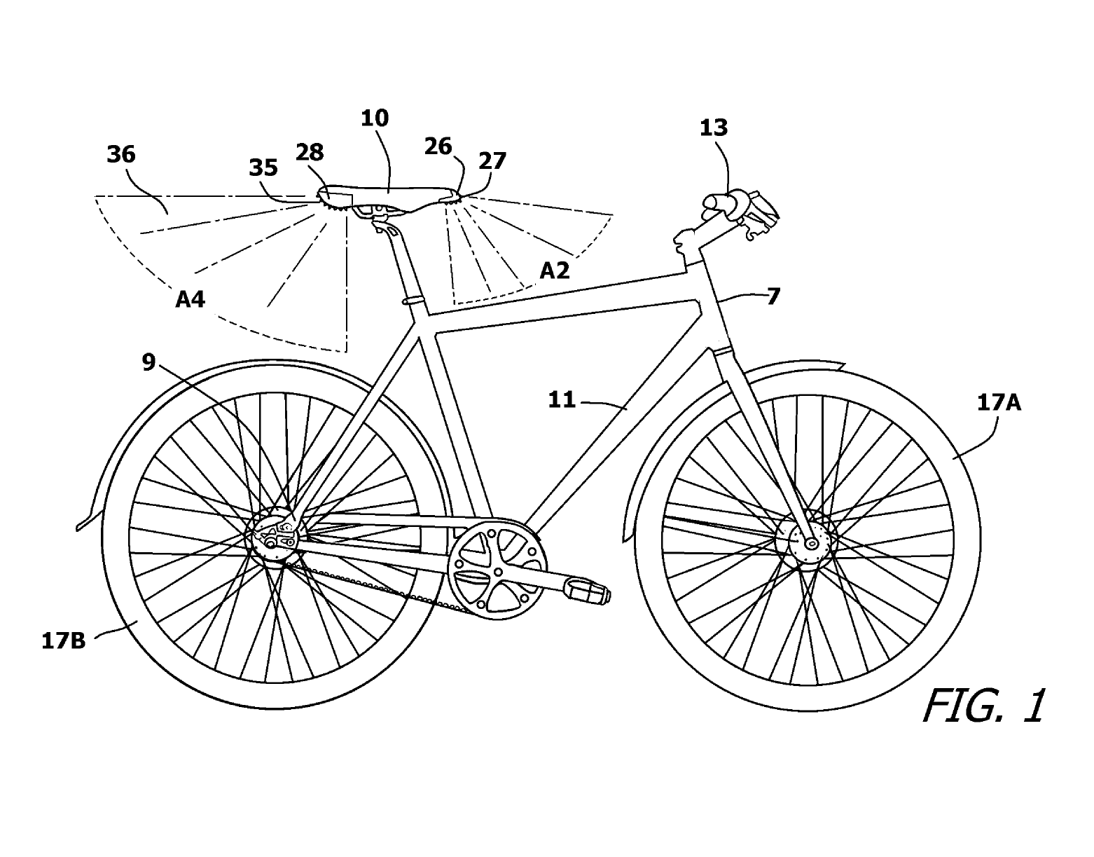

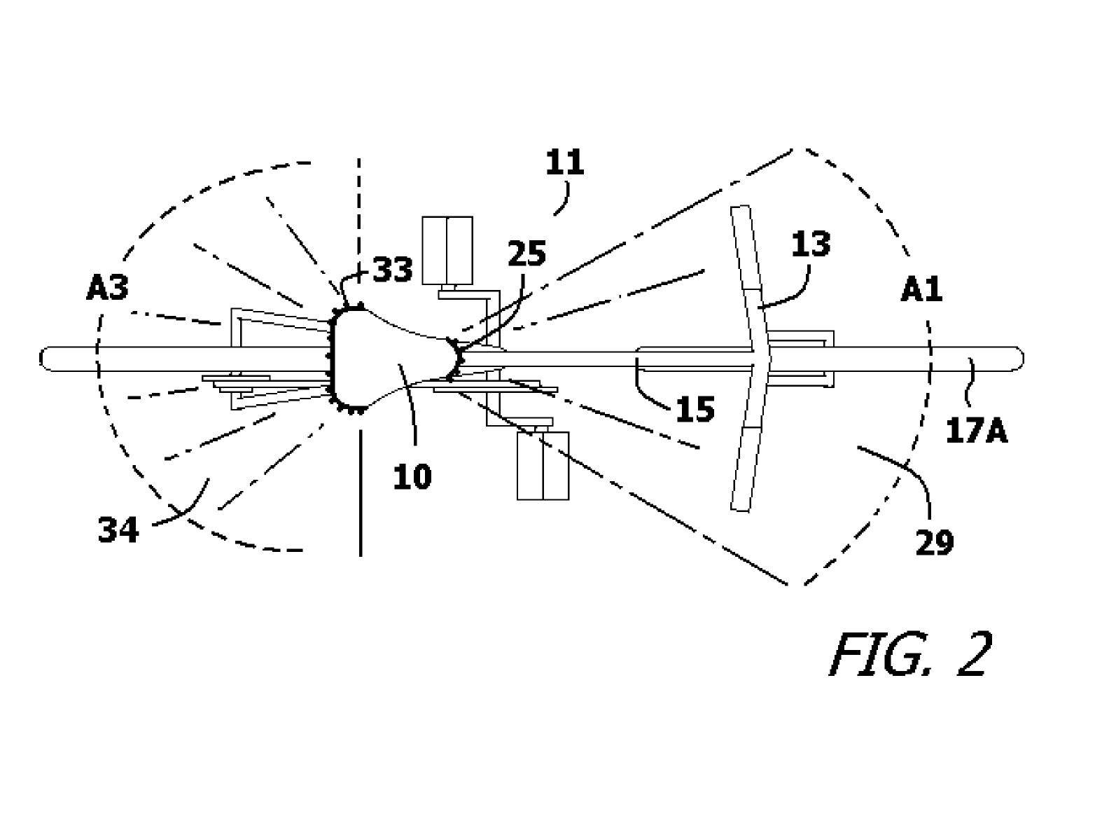

Referring to FIG. 1 and FIG. 2, a bicycle 11 is shown. The bicycle 11 has a bicycle seat assembly 10 and handlebars 13 that are mounted to a bicycle frame 15. The bicycle frame 15 has a front first end 7 and a rear second end 9. The bicycle frame 15 is supported upon two bicycle wheels 17A, 17B. The front wheel 17A mounts to the front first end 7 of the frame 15 and the rear wheel 17B mounts to the rear second end 9 of the frame 15. In most applications, the seat assembly 10 is the most elevated component on the bicycle 11 or is a close second to the elevation of the handlebars 13.

The bicycle seat assembly 10 contains lights that are used to illuminate the bicycle 11 and its surroundings by projecting light in multiple planes. As will be explained in more detail, the lights on the bicycle seat assembly 10 contain frame lights and running lights. The frame lights are used to directly illuminate the frame 15 of the bicycle 11 in front of, and behind, the position of the seat assembly 10. The running lights shine away from the frame 15 to illuminate the areas surrounding the bicycle 11 and to make the bicycle 11 highly visible in low light conditions.

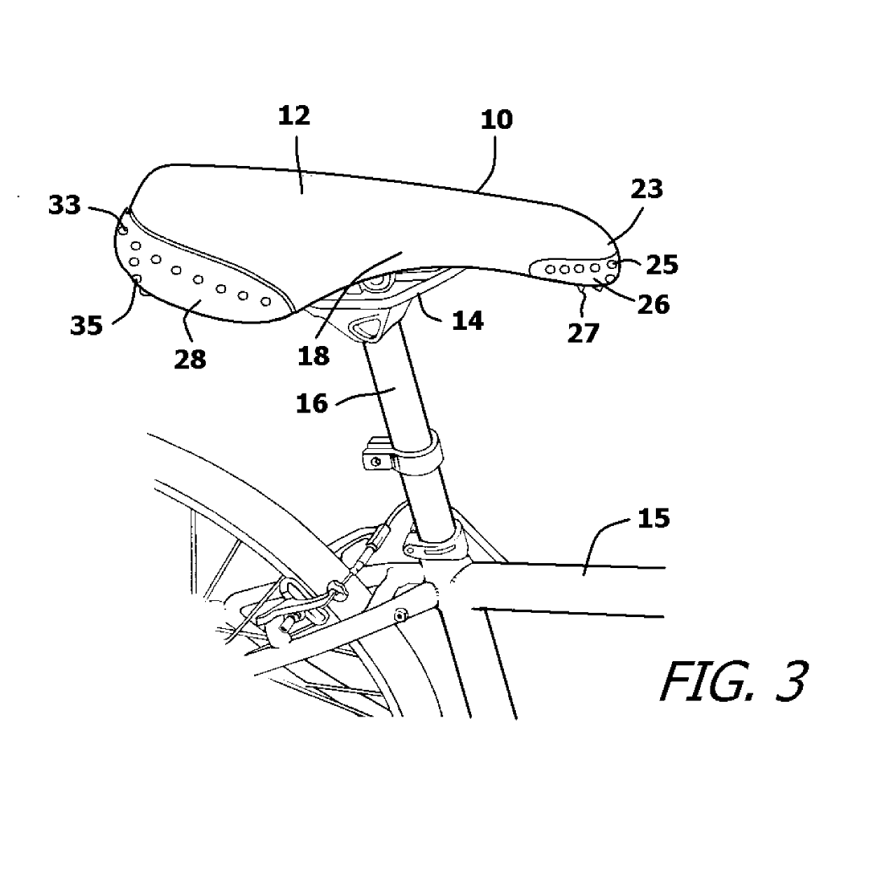

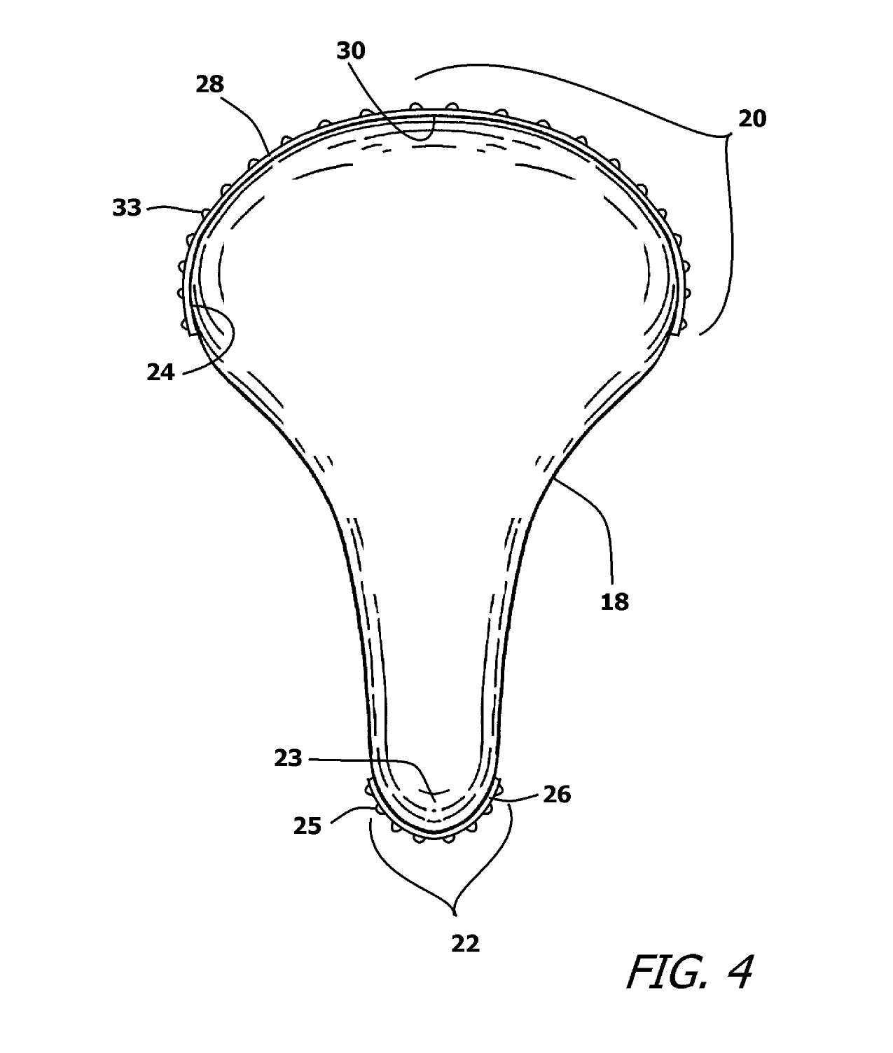

Referring to FIG. 3 and FIG. 4 in conjunction with FIG. 1 and FIG. 2, a bicycle seat assembly 10 is shown that incorporates an integrated illumination system. A padded seat 12 is provided that is mounted upon a support frame 14. The support frame 14 engages a shaft 16 that is received by the underlying bicycle frame 15. The padded seat 12 has a general V-shape, wherein the wide hind section 20 of the padded seat 12 tapers to a narrow forward section 22. The narrow forward section 22 terminates with the nose 23 of the padded seat 12. When a rider sits upon the padded seat 12, the rider's buttocks rest upon the wide hind section 20. The narrow forward section 22 of the padded seat enables the rider's legs to move up and down when pedaling without contacting the seat assembly 10.

Due to the forward facing position of a person riding the bicycle 11, the rider's legs extend to the contoured sides 18 of the padded seat 12 between the wide hind section 20 and the narrow forward section 22. Accordingly, the contoured sides 18 are obscured by the user's legs when the user is riding the bicycle 11. However, side surfaces 24 of the hind section 20 at its widest point remains exposed when a rider sits on the padded seat 12. Additionally, the nose 23 of the padded seat 12 remains unobstructed by the seated rider.

The bicycle seat assembly 10 supports two separate light arrays. Those light arrays include a forward light array 26 and a rearward light array 28. The forward light array 26 is mounted to the narrow forward section 22 of the padded seat 12. The rearward light array 28 is mounted to the unobstructed wide hind section 20 of the padded seat 12. Both the forward light array 26 and the rearward light array 28 contain both frame illumination lights and running lights.

The forward light array 26 is affixed to the narrow forward section 22 of the padded seat 12. The forward light array 26 contains LEDs oriented for two purposes. A first set of LEDs 25 are used as running lights and are positioned to shine light in directions that diverge away from the primary plane of the bicycle frame 15. The first set of LEDs 25 is best shown in FIG. 2 and FIG. 4 and is positioned to create an arced area of forward illumination 29. The arced area of forward illumination 29 shines light in an arc angle A1 that ranges from 45 degrees to 90 degrees, as measured in a horizontal plane. The arc angle A1 is bisected by the front of the bicycle 11. The forward light array 26 shines light out in front of the padded seat 12. The light therefore shines away from the bicycle 11. The light therefore serves to illuminate the areas around the front of the bicycle 11 and to serve as running lights to observers of the bicycle 11. Accordingly, the arced area of forward illumination 29 both illuminates the path of the bicycle 11 and provides a strong light signal that shows the position of the bicycle 11 to an observer.

The forward light array 26 also contains a second set of LEDs 27 that are oriented as frame illumination lights. The second set of LEDs 27 shines light directly onto the frame 15 of the bicycle 11. This illuminates much of the bicycle frame 15 forward of the seat assembly 10 between the seat assembly 10 and the front first end 7 of the bicycle frame 15. This makes the bicycle frame 15 much easier to observe during low light conditions. The second set of LEDs 27 is best shown in FIG. 1 and FIG. 3 and is positioned to create an arced area of vertical illumination 31. The arced area of vertical illumination 31 shines light in an arc angle A2 that ranges from 90 degrees to 45 degrees, as measured in a vertical plane. The light therefore shines onto the frame 15 and handlebars 13 of the bicycle 11 between the seat assembly 10 and the front first end 7 of the bicycle fame 15. The light therefore serves to directly illuminate the front of the bicycle 11 and shows the position of the bicycle 11 to an observer.

The hind section 20 of the padded seat 12 has a rear surface 30 and opposing side surfaces 24 that remain in plain site when a rider sits upon the padded seat 12. The rearward light array 28 is mounted to the rear surface 30 and opposing side surfaces 24. The rearward light array 28 contains LEDs oriented for two purposes. A first set of LEDs 33 is used as running lights and is positioned to shine light in directions that diverge away from the bicycle frame 15. The first set of LEDs 33 is best shown in FIG. 2 and FIG. 4 and is positioned to create an arced area of rearward illumination 34. The arced area of rearward illumination 34 shines light in an arc angle A3 that ranges from 160 degrees to 190 degrees, as measured in a horizontal plane. The arc angle A3 is bisected by the rear of the bicycle 11. The rearward light array 28 shines light behind the padded seat 12. The light therefore shines away from behind the bicycle 11. The light therefore serves to illuminate the areas behind the bicycle 11 and to serve as running lights to observers of the bicycle 11. Accordingly, the arced area of rearward illumination 34 provides a strong light signal that shows the position of the bicycle 11 to an observer approaching from the rear.

The rearward light array 28 also contains a second set of LEDs 35 that are oriented as frame illumination lights. The second set of LEDs 35 shines light directly onto the frame 15 of the bicycle 11 between the seat assembly 10 and the rear second end 9. This illuminates much of the bicycle frame 15 behind the seat assembly 10, which makes the bicycle frame 15 much easier to observe during low light conditions. The second set of LEDs 35 is best shown in FIG. 1 and FIG. 3 and is positioned to create an arced area of vertical illumination 36. The arced area of vertical illumination 36 shines light in an arc angle A4 that ranges from 90 degrees to 45 degrees, as measured in a vertical plane. The light therefore shines onto the frame 15 and rear wheel 17B of the bicycle 11. The light therefore serves to directly illuminate the rear of the bicycle 11 and shows the position of the bicycle 11 to an observer.

Referring to FIG. 4 in conjunction with FIG. 2, it will be understood that the first set of LEDs 33 of the rearward light array 28 is mounted on the wide hind section 20 of the padded seat 12. The wide hind section 20 presents a curved surface. Some of the LEDs on the side surfaces 24 shine light at a perpendicular to those on the rear surface 30. Other LEDs shine light at a variety of acute angles within the perpendicular range. As will later be explained, the LEDs may come in a variety of colors and may flash in predetermined patterns to increase the visibly of the bicycle seat assembly 10 during lowlight conditions.

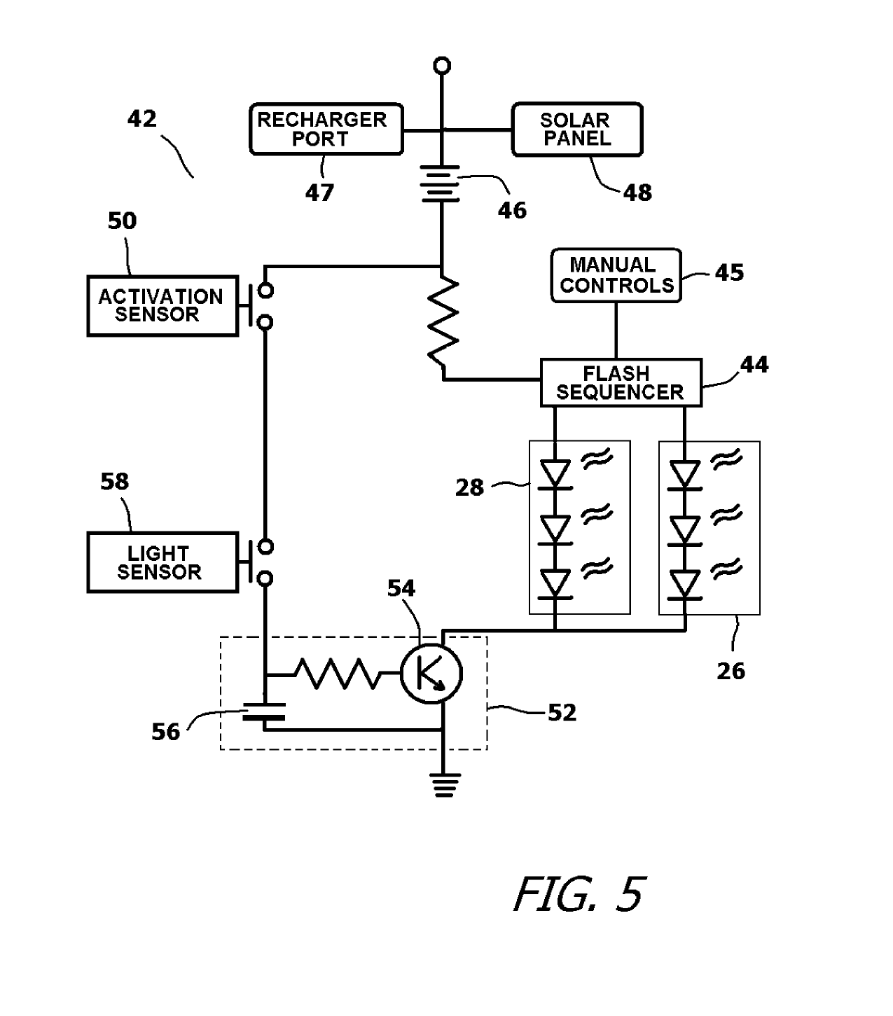

Referring to FIG. 5 in conjunction with FIG. 3, it will be understood that the rearward light array 28 and the forward light array 26 both contain a multitude of individual LEDs 40. All the individual LEDs 40 can be a common color, such as red. However, different color LEDs, such as white LEDs, red LEDs and blue LEDs can be present in the arrays as well.

The lighting of the individual LEDs 40 is governed by a control circuit 42. The control circuit 42 may simply light all of the LEDs 40 at one time. However, it is preferred that the control circuit 42 contains a sequencer 44 that flashes at least some of the LEDs 40 in some predetermined pattern. If more than one color LED is present, the sequencer 44 may alternately flash the LEDs of different colors to make a highly visible display. Manual controls 45 in the form of switches or buttons may be provided so that a user can select the flashing pattern from among a plurality of possible flashing patterns. The manual controls 45 can also be used to turn the electronics on and off.

The LEDs 40 are all powered by a common battery supply 46. The battery supply 46 is affixed to the support frame 14 under the padded seat 12. At this location, the battery supply 46 can be accessed and replaced without having to remove the bicycle seat assembly 10 from the underlying bicycle 11. A charger port 47 can be provided if the battery supply 46 is rechargeable. Furthermore, an optional solar panel charger 48 can be provided that can be used to trickle charge the battery supply 46. The solar panel charger 48 can be attached to any part of the bicycle frame 15.

An activation sensor 50 is provided. The activation sensor 50 can be any switch or sensor capable of detecting if the bicycle 11 is being used by a rider. For instance, the activation sensor 50 can be a mechanical switch that is placed into the structure of the padded seat 12. In this manner, when a rider sits on the padded seat 12, the activation sensor 50 is activated to its “on” state. When a rider dismounts the bicycle 11, the activation sensor 50 automatically returns to its “off” state. The activation sensor 50 can also be a motion detector that detects motion of the bicycle 11, or a proximity sensor that detects presence of a rider.

Depending upon the type of activation sensor 50 selected, the activation sensor 50 may automatically change between its “off” state and “on” state as a person sits upon, and rises from, the padded seat 12. As the state of the activation sensor 50 changes, the LEDs 40 do not instantly turn off. The control circuit 42 considers the “off” condition of the activation sensor 50 to be a deactivation signal. A delay circuit 52 is provided to delay activation. The delay circuit 52 contains a transistor 54 that controls the activation of one or more of the LEDs 40. When the activation sensor 50 is in its “on” condition, the transistor 54 is on and current is directed through the transistor 54 to the LEDs 40. Simultaneously, when the activation sensor 50 is in its on configuration, a capacitor 56 is charged.

When a deactivation signal is received, the capacitor 56 begins to discharge to the transistor 54. This keeps the transistor 54 on for as long as it takes to discharge the capacitor 56. Depending upon the size of the capacitor 56, this can take a few seconds or a few minutes. While the transistor 54 is on, the LEDs 40 remain lit. The delay circuit 52 causes the LEDs 40 to remain on and activated for a short period after a rider rises up from the padded seat 12. In this manner, if a rider stands on the bicycle pedals when riding, the LEDs 40 do not instantly deactivate. However, if the activation sensor 50 determines that no rider has sat upon the padded seat 12 for a predetermined period of time, i.e. the time it takes for the capacitor 56 to discharge, the LEDs 40 are automatically deactivated.

In addition to the activation sensor 50, a light sensor 58 may also be provided. The light sensor 58 is exposed to ambient light on the rear surface 30 of the padded seat 12. If the ambient light being detected is above a predetermined threshold, it can be determined that daylight conditions exist. This prevents the LEDs 40 from activating during daylight conditions and wasting battery power.

It will therefore be understood that in order for the LEDs 40 to become activated, a rider must have been seated upon the padded seat 12 within the last few moments and the ambient light conditions must be below some predetermined threshold. If these conditions are met, the LEDs 40 will activate and the individual LEDs 40 will blink as dictated by the sequencer 44.

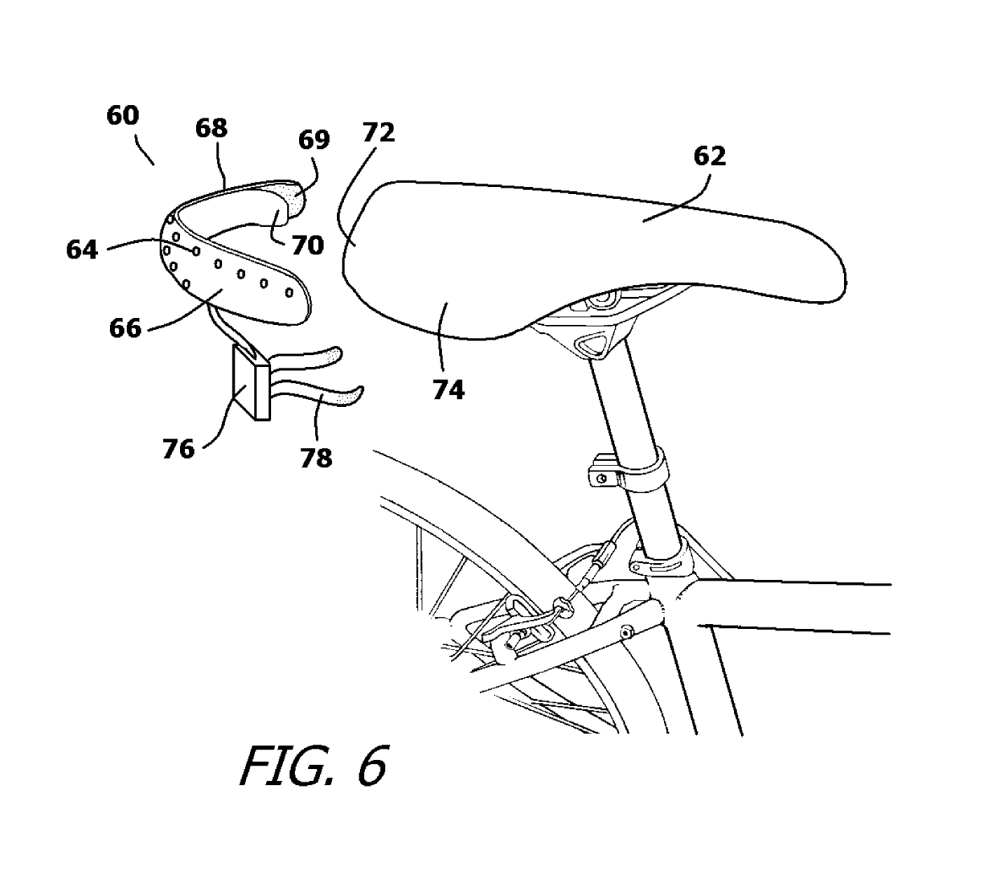

Referring now to FIG. 6, an alternate embodiment of a bicycle illumination system 60 is shown. In this embodiment, the illumination system 60 is separate from a prior art bicycle seat 62 and is intended to be added to the bicycle seat 62 in a retroactive manner.

In this embodiment, individual LEDs 64 are mounted to a flexible substrate 66 in order to form an array 68. The back of the substrate 66 is coated in adhesive 69 and is protected by a peel-away cover 70. The peel-away cover 70 is removed to expose the adhesive 69. The LED array 68 is then adhesively applied to the rear surface 72 and side sections 74 of the bicycle seat 62.

A housing 76 is provided. Within the housing 76 are located a battery supply and the circuitry needed to operate the illumination system 60 in the manner previously described. Straps 78 are affixed to the exterior of the housing 76. The straps 78 have hook and loop material on them and enable the straps 78 to engage around the frame of the bicycle seat 62 or the support shaft of the bicycle seat 62. As a result, the housing 76 can be mounted in position just below the bicycle seat 62.

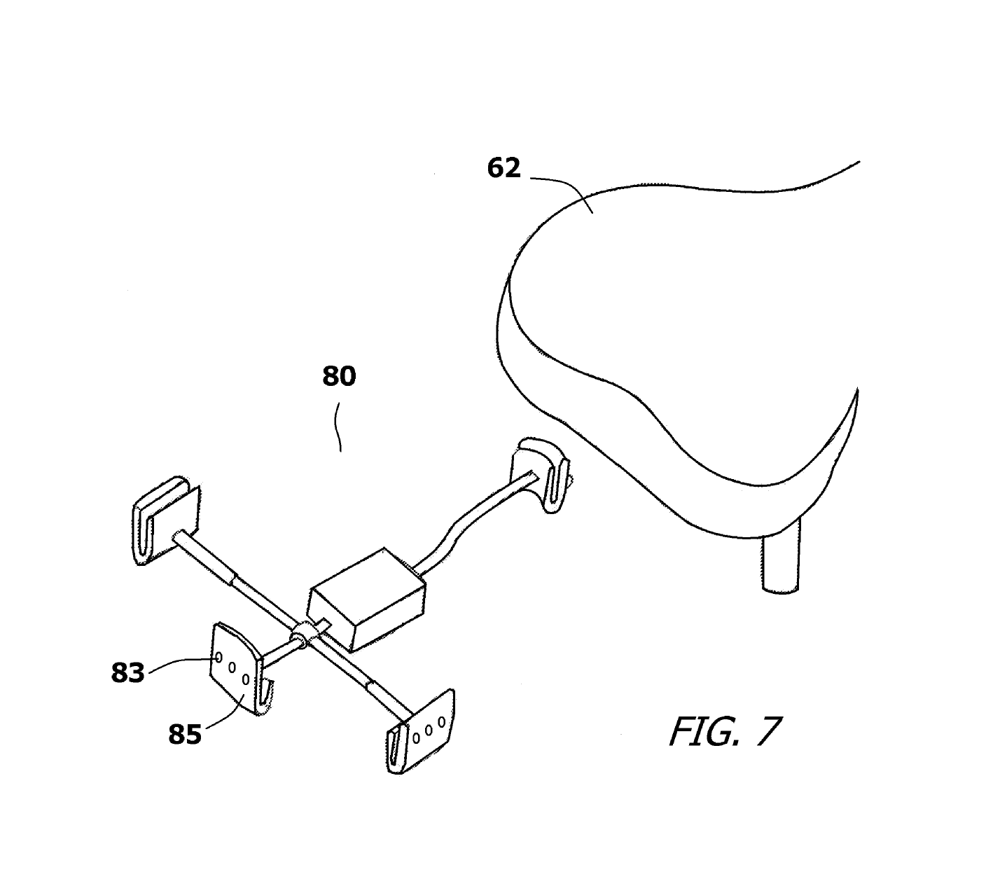

Referring now to FIG. 7, an alternate embodiment of a bicycle illumination system 80 is shown. In this embodiment, the illumination system 80 is separate from a prior art bicycle seat 62 and is intended to be added to the bicycle seat 62 in a retroactive manner.

In this embodiment, individual LEDs 83 are mounted to clip structures 85. The clip structures 85 clip onto the rear, sides and front of the bicycle seat 62. The distance between the various clip structures 85 is adjustable to accommodate a variety of seat sizes and configurations.

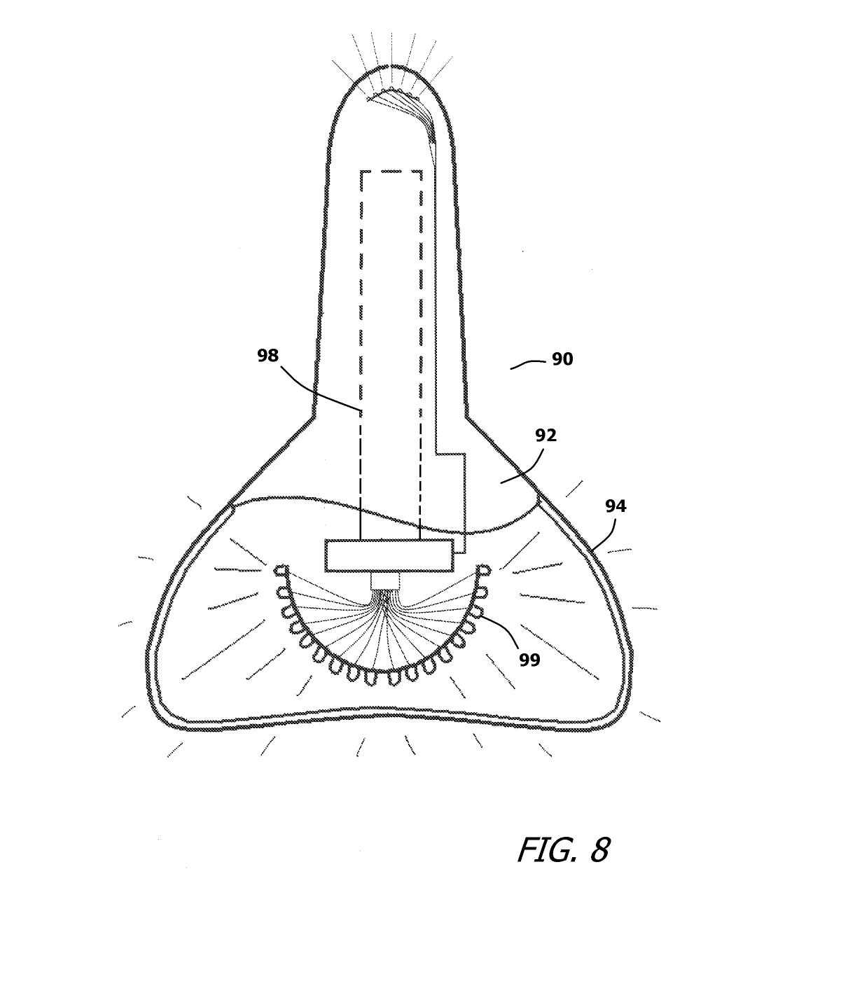

Referring now to FIG. 8 another alternate embodiment of the present invention is shown. In this embodiment, the present invention is configured as a full bicycle seat assembly 90. The bicycle seat assembly 90 has a padded seat 92. However, the side surfaces 94 of the padded seat 92 are made of a translucent plastic, such as polyurethane or polycarbonate.

Under the padded seat 92 is a light source 98. The light source 98 can contain LEDs, but may also be a laser light source. The light source 98 shines light into fiber optic elements 99. The fiber optic elements 99 direct light toward the side surfaces 94. This causes the sides surfaces 94 of the bicycle seat assembly 90 to be internally illuminated and glow during low light conditions.

It will be understood that the embodiments of the present invention that are illustrated and described are merely exemplary and that a person skilled in the art can make many variations to those embodiments. For instance, many bicycle seat shapes exist other than the one illustrated. The present invention can be adapted to any seat shape, size or model provided the seat has exposed side and rear edges. All such embodiments are intended to be included within the scope of the present invention as defined by the claims.

What is claimed is:

1. An illuminated bicycle, comprising:
a frame having a first end and an opposite second end;
a seat mounted to said frame between said first end and said second end;
a first light array supported by said seat that illuminates said frame between said seat and said first end of said frame; and
a second light array supported by said seat that illuminates said frame between said seat and said second end of said frame.

2. The bicycle according to claim 1, further including a sensor for detecting when said bicycle is in use and when said bicycle is not in use.

3. The bicycle according to claim 2, further including a controller that automatically activates said first light array and said second light array when said sensor detects said bicycle is in use.

4. The bicycle according to claim 3, wherein said controller deactivates said first light array and said second light array a period of time after said sensor detects said bicycle is not in use.

5. The bicycle according to claim 4, wherein said period of time is determined by a delay circuit within said controller.

6. The bicycle according to claim 1, wherein said first light array includes a first set of LEDs that are directed away from said frame to illuminate a first area around said bicycle.

7. The bicycle according to claim 6, wherein said first area is an arcuate area having an arc angle of between 45 degrees and 90 degrees.

8. The bicycle according to claim 6, wherein said first light array includes a second set of LEDs that are directed toward said frame to illuminate said frame between said seat and said first end of said frame.

9. The bicycle according to claim 1, wherein said second light array includes a first set of LEDs that are directed away from said frame to illuminate a second area around said bicycle.

10. The bicycle according to claim 9, wherein said second area is an arcuate area having an arc angle of between 160 degrees and 190 degrees.

11. The bicycle according to claim 9, wherein said second light array includes a second set of LEDs that are directed toward said frame to illuminate said frame between said seat and said second end of said frame.

12. The bicycle according to claim 3, wherein said controller further includes a flash sequencer circuit for flashing said first light array and said second light array.

13. An illuminated bicycle, comprising:
a frame having a first end and an opposite second end;
a seat mounted to said frame between said first end and said second end;
LEDs supported by said seat above said frame that illuminate said frame in a first area between said seat and said first end of said frame, and in a second area between said seat and said second end of said frame; and
a controller that activates said LEDs only when said bicycle is in use.

14. The bicycle according to claim 13, wherein said LEDs are arranged in a first light array and a second light array,
wherein said first light array illuminates said frame between said seat and said first end of said frame, and
said second light array illuminates said frame between said seat and said second end of said frame.

15. The bicycle according to claim 14, wherein said controller includes a sensor for detecting when said bicycle is in use and when said bicycle is not in use.

16. The bicycle according to claim 15, wherein said controller deactivates said first light array and said second light array a period of time after said sensor detects said bicycle is not in use.

17. The bicycle according to claim 16, wherein said period of time is determined by a delay circuit within said controller.

18. The bicycle according to claim 14, wherein said first light array includes a first set of LEDs that are directed away from said frame to illuminate a first area around said bicycle.

19. The bicycle according to claim 14, wherein said second light array includes a first set of LEDs that are directed away from said frame to illuminate a second area around said bicycle.

20. The bicycle according to claim 13, wherein said controller further includes a flash sequencer circuit for flashing said first light array and said second light array.
